(19) United States
(12) Patent Application Publication
(10) Pub. No.: US 2025/0315148 A1
(43) Pub. Date: Oct. 9, 2025

(54) SYSTEM AND METHOD FOR ENHANCING ON-LINE BROWSING USING AUTOMATED AGENTS

(71) Applicant: Bluecore, Inc., New York, NY (US)

(72) Inventors: Max Bennett, New York, NY (US); Kenny Teng, Brooklyn, NY (US); Jason Deng, Brooklyn, NY (US)

(21) Appl. No.: 19/242,652

(22) Filed: Jun. 18, 2025

Related U.S. Application Data
(63) Continuation-in-part of application No. 18/518,286, filed on Nov. 22, 2023.
(60) Provisional application No. 63/524,499, filed on Jun. 30, 2023.

(51) Int. Cl. G06F 3/04817; G06F 3/0483; G06F 3/0484; G06Q 30/0601

(52) U.S. Cl. CPC G06F 3/04817; G06F 3/0483; G06F 3/0484; G06Q 30/0641

(57) ABSTRACT

A system and associated method for simplifying and enhancing a customer browsing experience on websites. In an embodiment, the method involves, upon determining that a customer has clicked on a clickable prompt button embedded at a website, in association with a specific product or article, displaying instantaneous product information to the user without requiring the user to type in lengthy requests. In another embodiment, upon determining that a customer has clicked on a clickable prompt button embedded at a website, providing means for enabling the customer to interact with a large language model that is capable of responding with specificity to user questions about products on the websites based on contextual information transparently provided by the clickable prompt buttons.

### CROSS REFERENCE TO RELATED APPLICATIONS

The present application is a continuation-in-part application and claims the priority benefit of U.S. patent application Ser. No. 18/518,286 filed on Nov. 22, 2023, titled “System and Method for Simplifying On-Line Browsing on Websites Using Embeddable Clickable Prompt Buttons” which claims the priority benefit of U.S. Provisional Application Ser. No. 63/524,499 filed on Jun. 30, 2023, titled “Click-to-Prompt”. This application is related to U.S. patent application Ser. No. 19/227,155, titled “Dynamic Generative Skill Agents Using Large Language Models” which is a Continuation in Part and claims the priority benefit of U.S. patent application Ser. No. 18/589,343, filed on Feb. 27, 2024, titled “Dynamic Frequently Asked Questions Using Large Language Models”, which claims the priority benefit of U.S. Provisional Patent Application Ser. No. 63/542,995, filed on Oct. 6, 2023, titled “Personalized Frequently Asked Questions Using Large Language Models”. These applications are hereby incorporated by reference in their entirety, including all appendices.

### FIELD

The present disclosure pertains generally to browsing on electronic commerce (“e-commerce”) websites over the Internet and more specifically to a system and method that simplifies on-line browsing on e-commerce websites using embeddable clickable prompt buttons that interact with large language models.

### BACKGROUND

Interacting with websites can often frustrate users by requiring users to click through endless pages and search through long product detail pages or articles for the information they need when making a decision. The problem with using large language model based chatbots to solve this problem is that, while it enables users to access large amounts of information, it requires users to (1) type in long prompts and (2) make clear what products or elements in the page they are referring to, both of which are time consuming. This can result in users abandoning the website, reducing conversion rates and negatively impacting customer satisfaction. To mitigate these and other problems, it would be desirable for websites to focus on enhancing the user experience by minimizing the amount of time it takes for users to get the information they need in order to make a purchase decision.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

The present disclosure is related to various systems and methods for utilizing clickable prompt buttons, embedded on websites, that interact with large language models to simplify and enhance a user browsing experience. Use of the embedded clickable prompt buttons advantageously streamline a user browsing experience by obviating the need for the users to tediously type out requests on websites or search through long pages for information. Instead, quick action clickable prompt buttons are pre-programmed to respond to common user requests, simply by clicking on the button. The clickable prompt buttons also provide capabilities for enabling users to interact with large language models that use product specific contextual information, provided by the buttons to the large language models to educate users about products of interest via an interactive chat session.

According to some embodiments, the present disclosure relates to a computer-implemented method. The method comprising, detecting a user engagement with a clickable prompt button embedded on a web page displayed at a computing device; determining a type of detected clickable prompt button; upon determining that the detected clickable prompt button is a type-1 clickable prompt button: transmitting, to an interactive large language model (LLM) at a remote server, systemic context information; processing, by the LLM at the remote server, the systemic contextual information to generate first parametric output data; transmitting, from the remote server, the first parametric output data to the computing device; upon determining that the detected clickable prompt button is a type-2 clickable prompt button: transmitting, to the remote server, systemic context information from the computing device; requesting, from the computing device, customer context information, via a pop-up chat interface; receiving, at the remote server, the requested customer context information; processing, by the LLM at the remote server, the systemic context information to generate second parametric output data; and processing, by one or more third party servers, the customer context information to generate outside source data; and transmitting, to the computing device, a user response comprising the second parametric output data and the outside source data.

According to some embodiments, the present disclosure relates to a system comprising: a processor and a memory for storing instructions, the instructions being executed by the processor to: detect a user engagement with a clickable prompt button embedded on a web page displayed at a computing device; determine a type of detected clickable prompt button; upon determining that the detected clickable prompt button is a type-1 clickable prompt button: transmit, to an interactive large language model (LLM) at a remote server, systemic context information; process, by the LLM at the remote server, the systemic contextual information to generate first parametric output data; and transmit, from the remote server, the first parametric output data to the computing device; upon determining that the detected clickable prompt button is a type-2 clickable prompt button: transmit, to the remote server, systemic context information from the computing device; request, from the computing device, customer context information, via a pop-up chat interface; receive, at the remote server, the requested customer context information; process, by the LLM at the remote server, the systemic context information to generate second parametric output data; process, by one or more third party servers, the customer context information to generate outside source data; and transmit, to the computing device, a user response comprising the second parametric output data and the outside source data.

According to one aspect of the present disclosure, a non-transitory computer-0readable storage medium having embodied thereon instructions, which when executed by a processor, performs steps of the methods substantially as described herein.

Other example embodiments of the disclosure and aspects will become apparent from the following description taken in conjunction with the following drawings.

### BRIEF DESCRIPTION OF THE DRAWINGS

Certain embodiments of the present technology are illustrated by the accompanying figures. It will be understood that the figures are not necessarily to scale and that details not necessary for an understanding of the technology or that render other details difficult to perceive may be omitted. It will be understood that the technology is not necessarily limited to the particular embodiments illustrated herein.

It will be understood that like or analogous elements and/or components, referred to herein, may be identified throughout the drawings with like reference characters.

FIG. 1 is a schematic diagram of an example wireless environment where aspects of the present disclosure can be implemented for use.

FIG. 2 diagrammatically illustrates a system configured for use with a disclosed method of operation based on a type-1 clickable prompt element, according to one embodiment.

FIG. 3A diagrammatically illustrates a system configured for use with a disclosed method of operation based on a type-2 clickable prompt element according to one embodiment.

FIG. 3B diagrammatically illustrates a system configured for use with a disclosed method of operation based on a type-2 clickable prompt element according to one embodiment.

FIGS. 4A & 4B is a flowchart of an example method 400 of the present disclosure for using clickable prompt buttons and large language models to simplify and enhance a user browsing experience on websites.

FIGS. 5-11 are exemplary illustrative examples of a method for using clickable prompt buttons for interacting with large language models, according to some embodiments.

FIG. 12 is an exemplary illustrative user-interface screen illustrating PDP widgets as an implementation of a clickable prompt button, according to one embodiment.

FIG. 13 is an exemplary illustrative user-interface screen illustrating various selectable PDP skills, according to one embodiment.

FIG. 14 is an exemplary illustrative architecture of a prompt generation subsystem, according to one embodiment.

FIG. 15 is an exemplary illustrative user-interface screen for configuring and managing a prompt template repository, according to one embodiment.

FIG. 16 is a simplified block diagram of a computing system, according to some embodiments.

### DETAILED DESCRIPTION

Before the invention is described in further detail, it is to be understood that the invention is not limited to the particular embodiments described, as such may, of course, vary. It is also to be understood that the terminology used herein is for the purpose of describing particular embodiments only, and not intended to be limiting, since the scope of the present invention will be limited only by the appended claims.

The present disclosure addresses issues related to simplifying and thereby enhancing a user's on-line browsing experience at an e-commerce website. In some embodiments, during a configuration stage, a clickable prompt button is created by a web designer to be embedded on an e-commerce website or a mobile app. Thereafter, during an operational stage, a user viewing the website may click on the embedded clickable prompt button to quickly receive product information about products displayed on the website without the need to type in long-form user requests, as required in conventional browsing. The clickable prompt buttons are constructed as software objects that incorporate functionality for rapidly and seamlessly responding to the user requests. Typical user requests made to e-commerce websites, such as, “how much is this”, “how does this compare to that”, and “what kind of boot works with this ski” are responded to by the clickable prompt buttons without requiring the users to manually type in the requests and without having to inform the chatbot of what product they are referring to. In one embodiment, the clickable prompt buttons software objects perform the methods described herein under control of a client-side java software application. In other embodiments, the clickable prompt buttons act autonomously. A basic feature of the present disclosure is the ability of the clickable prompt buttons to provide contextual information about products on websites to large language models to enable the large language models to respond to user queries via the clickable prompt buttons.

### Terminology

The terms “web page” or simply “page”, as referred to herein, may refer to a document whose source code is typically written in plain text interspersed with formatting instructions of Hypertext Markup Language (HTML, XHTML) and optionally CSS, which web page contains content such as text, images, video, audio, hyperlinks, etc. The source code may be statically-available or dynamically-composed at a web server, and transmitted to a client-side web browser over Hypertext Transfer Protocol (HTTP). After the web browser receives the source code, it may further alter the source code.

The term “web site”, as referred to herein, may refer to a set of related web pages. A web site is hosted on at least one web server, accessible via a network, such as the Internet or a private local area network, through an Internet address known as a Uniform Resource Locator (URL). Web pages of a web site are usually requested and served from a web server using a protocol such as HTTP (HyperText Transfer Protocol), HTTPS (HyperText Transfer Protocol-Secured), Web Sockets, etc. All publicly accessible websites collectively constitute what is known as the World Wide Web.

The term “web browser”, as referred to herein, may refer to a software application, or a component of a software application, for example, a web browser component as a part of a graphical user interface (GUI)), for retrieving, rendering and presenting information resources from the World Wide Web and/or other sources. Web browsers enable users to access and view documents and other resources located on remote servers. Some of the major web browser applications today are Google Chrome, Mozilla Firefox, Microsoft Internet Explorer, Opera, and Apple Safari. A web browser typically retrieves source code of a webpage, and any associated media and/or files, from a server using HTTP, renders it locally and presents it graphically to a user.

The term “client-side script” or “client-side code”, as referred to herein, may refer to a programming script which is executable by a web browser, thereby affecting the graphical view of a web page and/or otherwise affecting a behavior of the web browser. The programming script may be written, for example, in any one of Java-script, Java, Microsoft Silverlight and Adobe Flash.

The term “Java-script”, as referred to herein, may refer to a specific scripting language for client-side scripts, commonly implemented as part of web browsers in order to create enhanced user interfaces and/or dynamic websites. Java-script was formalized in the ECMAScript language standard and is primarily used in the form of client-side Java-script, namely—as part of a web browser. See Ecma International, Standard ECMA-262: ECMAScript Language 20 Specification, Edition 5.1 (June 2011), available at http://www.ecma-international.org/publications/standards/Ecma-262.htm; and International Organization for Standardization, Standard ISO/IEC 16262:2011: ECMAScript language specification, available at http://www.iso.org/iso/home/store/catalogue_tc/catalogue_detail.htm?csnumber=55755.

The term “Software Object”, as referred to herein, may refer to the clickable prompt button as a self-contained unit that combines both data (attributes or properties) and behavior (methods or functions) into a single entity, as described below.

The term “Systemic context information”, as referred to herein, may refer to context information that is collected on the client side (e.g, by a java-script application) to be transmitted to a remote interactive large language model (LLM) in response to an user “clicking” on a clickable prompt button embedded on a website. The systemic context information provides context to the LLM in generating an informed response to a user “clicking” on the clickable prompt button. Examples of systemic context information may include: a product ID, a current URL. For example, when a user clicks on the clickable prompt button, the product ID may be passed to the LLM as systemic context information which allows the LLM to use the product ID as input data to generate an informed response to the user to educate the user about an item being displayed in association with the clickable prompt button.

The term “Customer context information”, as referred to herein, may refer to context information that is tracked, collected and stored in a memory on the client side computing device for eventual transmission to an interactive large language model (LLM). In an embodiment, the customer context information is transmitted to the LLM upon detecting a user engagement with a clickable prompt button. The customer contextual information is provided to the LLM to provide context to the LLM in responding to the user clicking on the clickable prompt button to inquire about a item on display at a commercial website. Examples of customer context information may include, past browsing history of a customer, current browsing history of a customer, prior clicks of a customer, past purchase history, past search history, customer physical location, customer cart contents, a customer profile on file, or any suitable combination thereof.

The term “Parametric data”, as referred to herein, may refer to any data that is generated by an interactive large language model (LLM) as output responsive to a user query when clicking on a clickable prompt button.

The term “Outside Source data”, as referred to herein, may refer to data that is generated by one or more third party servers based on the customer context information received from the LLM.

The term “Customer response data”, as referred to herein, may refer to follow up information manually provided by the user in accordance with a type-2 prompt in which the LLM makes at least one additional information request from a user. For example, a user may provide “customer response data” when responding to the at least one additional LLM prompt “What is your question about product X?.”

The term “Type-1 clickable prompt button”, as referred to herein, may refer to an embodiment in which a large language model (LLM) makes a single information request from a user to obtain context information from the user.

The term “Type-2 clickable prompt button”, as referred to herein, may refer to an embodiment in which a large language model (LLM) makes at least one additional information request from a user to obtain further context information from the user.

### EXAMPLE EMBODIMENTS

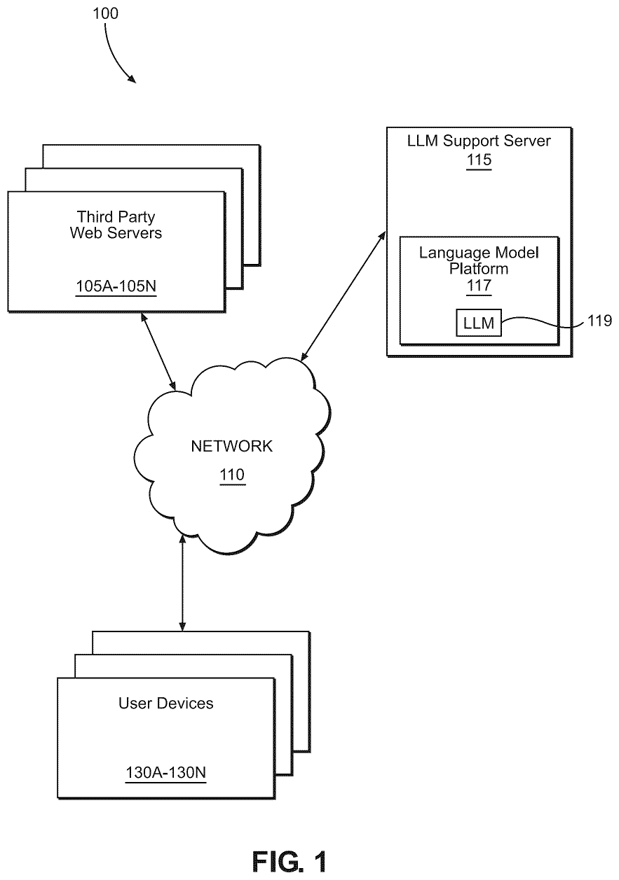

Turning now to the drawings, FIG. 1 illustrates an example architecture 100 in which various embodiments of the present disclosure may be implemented. The architecture 100 includes user devices 130A-130N, third-party web servers 105A-105N, an LLM support server 115 hosting a large language model (LLM) platform 117 including a large language model 119, where each of the user devices 130A-130N, third-party web servers 105A-105N and LLM support server 115 can be communicatively coupled over a network 110.

The user devices 130A-103N can include any functioning computer device, such as a desktop computer or a laptop computer. Alternatively, other computing devices, are within contemplation for use in the architecture 100 such as a tablet PC, a smart-phone, a personal digital assistant, an Internet-of-Things (IoT) device or system, a personal digital assistant (PDA), a cellular telephone, a web appliance or any machine capable of executing a set of instructions capable of specifying actions to be taken by that machine.

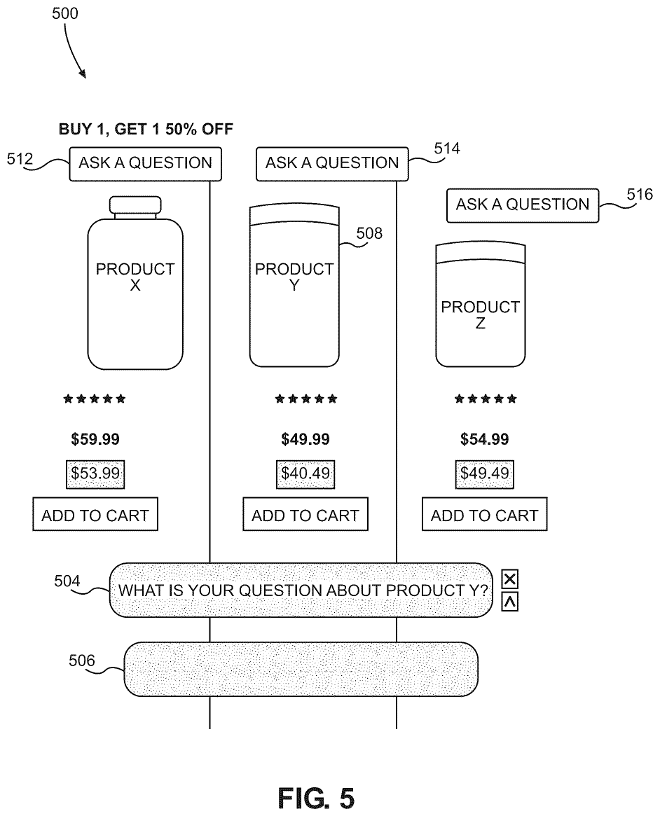

The language model platform 117 hosts a large language model (LLM) 119 configured to respond to user requests at websites based in part on contextual information received from clickable prompt buttons (See FIGS. 5-7) displayed at the websites and transmitted from the user devices 130A-130N displaying the websites.

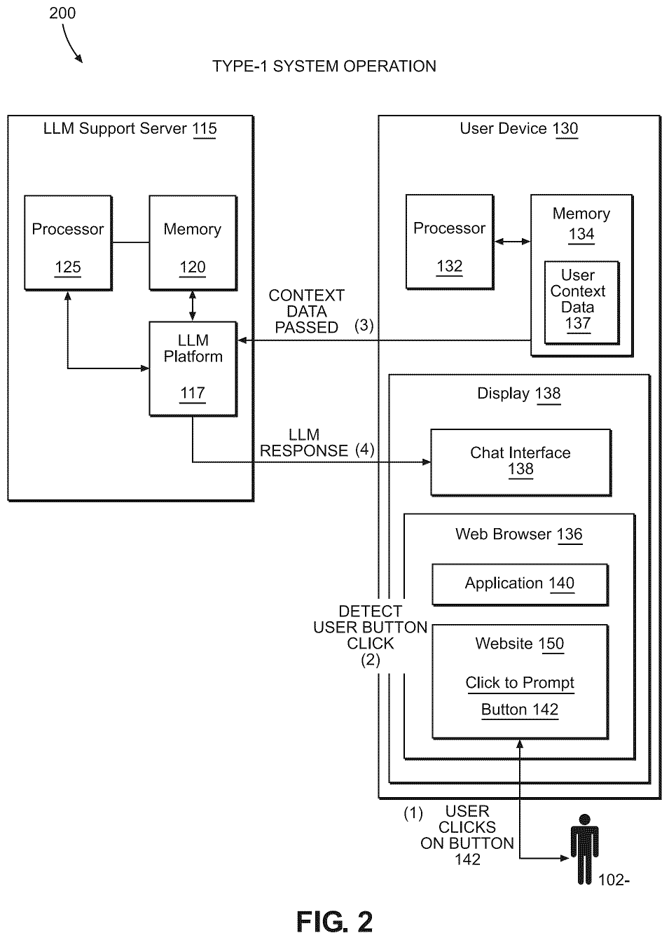

In some embodiments, the operations of the clickable prompt buttons are controlled by a java-script that may be embedded on a client side device (See FIG. 2, 140). The java-script file includes programmable code, such that when executed by a processor, is configured to control the operations of clickable prompt buttons as described in accordance with the methods disclosed herein.

According to one aspect, the clickable prompt buttons are preferably created during a pre-configuration stage. The creation of a clickable prompt button includes defining initial values for more or fixed fields, described as follows.

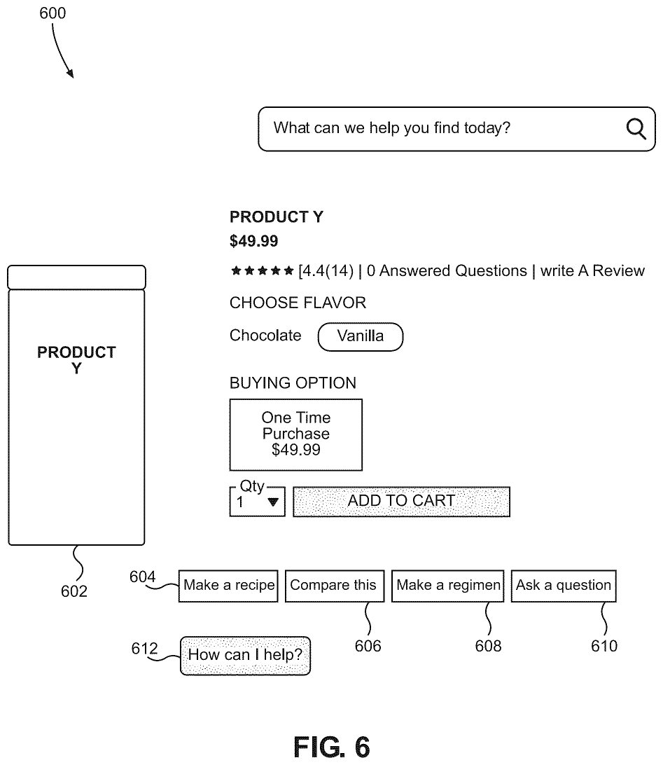

Display name—the display name is one of the fixed fields of the clickable prompt button software object and refers to text (i.e., label) that the user sees on a web page of an e-commerce web site. As an example, FIG. 5 illustrates one or more clickable prompt buttons with the display name, “Ask a Question”. FIG. 6 illustrates a variety of clickable prompt buttons with the respective display names, “make me a recipe” 604, “compare this” 606, “make a regimen” 608, and “ask a question” 610. Some embodiments will have the display name dynamically written by a large language model based on a user's browser behavior and the page the user is on. Other embodiments will hard code the display name on the button.

Object Identifier (ID)—The object identifier is one of the fixed fields of the clickable prompt button and refers to a specific object that is being referenced when a user clicks on a clickable prompt button. The object ID can refer to the object by its product ID or its article ID. In the case where the object ID refers to an object by its product ID, a large language model LLM, operating in concert with the clickable prompt button, can look up information about the product via the product I to fulfill a user inquiry. Alternatively, in the case where the Object ID refers to an object by its article ID, the large language model can look up information about the article to fulfill a user inquiry.

System message—The system message is one of the fixed fields of the clickable prompt button and refers to a message that is generated by a system of the present disclosure. The system message is passed from the clickable prompt button to a large language module to give the large language model some context that a user has just clicked on a clickable prompt button and that a response is required. Typically, the system message is not included in a chat history conducted between a user and the large language module and consequently never shown to a user while browsing an e-commerce website. As an example of a system message, a user may click on a clickable prompt button, e.g., “ask a question” for a product titled {{object.title}} with a product ID, {{object.id}}. This system message would be forwarded to the large language module to provide context but not be included in the chat history and therefore never shown to a user.

User message—The user message is one of the fixed fields of the clickable prompt button and refers to message that is generated by a system of the present disclosure. The user message is passed to the large language model in response to a user clicking on a clickable prompt button. The user message is included in a chat history conducted between the user and the large language module. In one aspect, the user message is sometimes referred to as artificial in the sense that the user message was never actually constructed by a user. However, the user message finds purpose in providing context the large language module, informing the LLM that a user just clicked on a clickable prompt button and that a correct response to a user query must be generated by the large language module. An example of a user message would be, when the user clicks on a clickable prompt button, entitled, “Ask a Question”, the system of the present disclosure automatically generates the following user message—“I have a question about {{object.title}}. This fictitious user message is automatically inserted into the chat history and shown to a user. The user message is also independently forwarded to a large language module to give the large language module context in responding to the user query submitted via a click of the “Ask a Question” clickable prompt button. In some embodiments, a user message will not require feedback from a large language module in the form of a follow up question. As an example of this case, when a user clicks on a clickable prompt button labeled, “make me a smoothie”, the system will generate the fictitious user message: “please make me a smoothie recipe using {{object.title}}.” In this example, the large language module has all the information it needs to make a smoothie and will display a smoothie recipe on the client computing device.

Optional AI message—this is a message that is generated by and issued from the LLM and is required only in those cases where the user is prompted by the LLM to respond to a question posed by the LLM, in an on-going chat session, seeking additional information about a product of interest to a user.

Having defined the fixed fields of an exemplary clickable prompt button to be embedded at a commercial website, a web builder client may assign values to the fixed fields during pre-configuration, in accordance with the following steps.

Step 1: the web builder client may select a display name for the clickable prompt button to be embedded at the web page. Display names, such as, “ASK A QUESTION”, are intended to prompt a user to inquire and/or learn about products on display at commercial websites.

Step 2: the web builder client may then assign a value to the object identifier field of a clickable prompt button to be embedded at a web page. The object identifier field refers to a specific object (e.g., item, product, or article) that is being displayed on a website. Typically, the object identifier field corresponds to a product ID of the item or product on display. As an example, clickable prompt button 512 (See, FIG. 5) is displayed in association with Product X. In this example, Product X is the assigned value for the object identifier.

Step 3: The web builder client may create a user message and/or a system message. User messages are shown to users in a chat history conducted between the users and a large language model, in certain cases when the clickable prompt button is clicked on. System messages are not shown to users in the chat history. Both user messages and system messages assist the large language models to respond to user requests and guide the users to interact with the large language models. As an example, a web builder client may decide to create a user message pertaining to a Product Y displayed on a website, where the user message is constructed to state—“What is your question about {{product.id}}?”. This user message would be displayed to the user in response to the user clicking on a clickable prompt button, labeled, “Ask a question”.

### System Operation

FIG. 2 describes a system operation that is performed when a user “clicks on a type-1 click to prompt button displayed at an e-commerce web site.

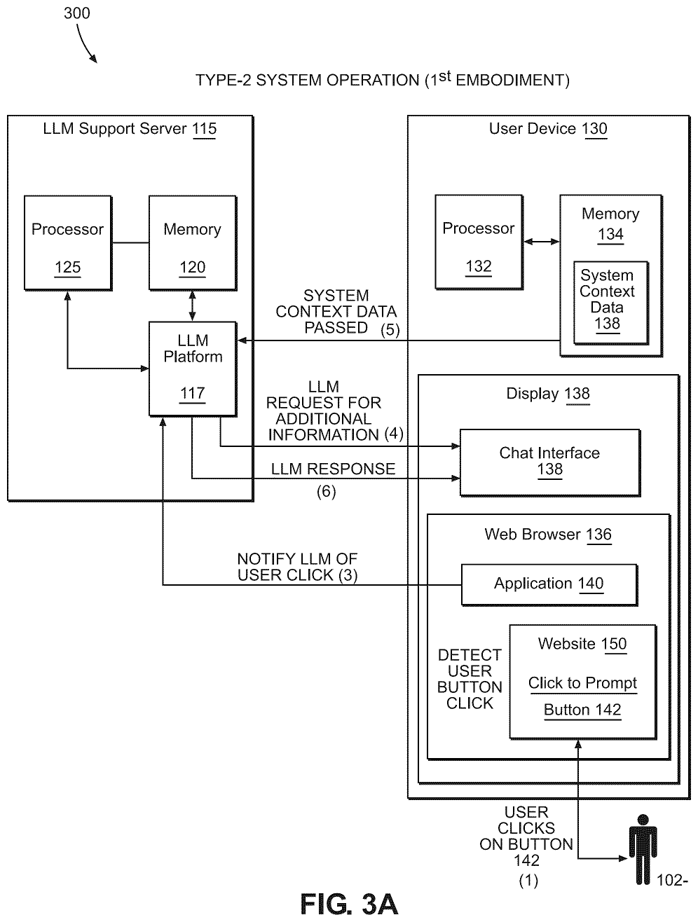

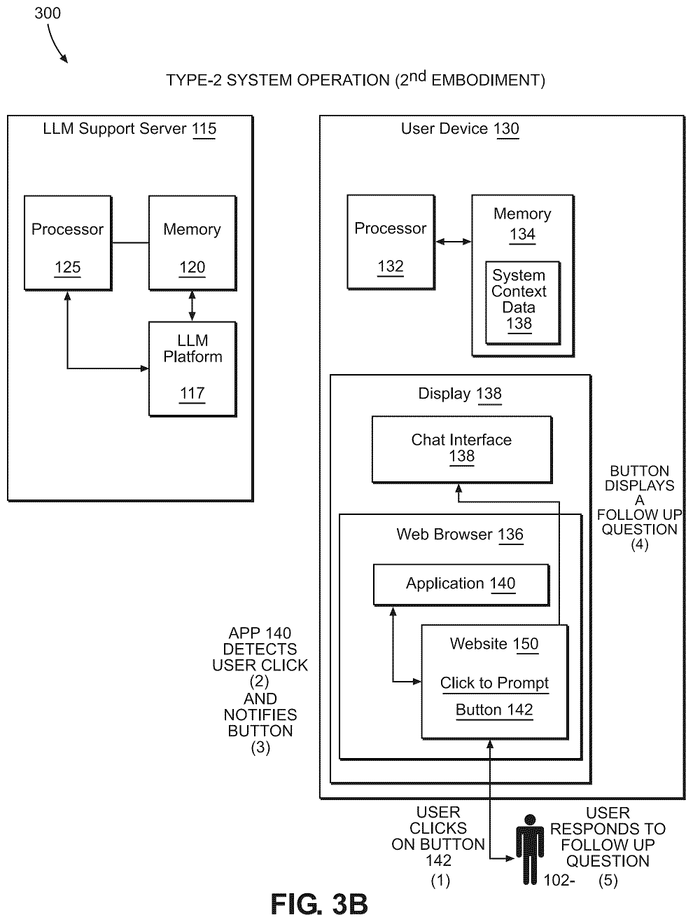

FIG. 3A, describes a system operation when a user clicks on a type-2 “click to prompt” button displayed at an e-commerce web site including assistance from an LLM.

FIG. 3B, describes a system operation when a user clicks on a type-2 “click to prompt” button displayed at an e-commerce web site without assistance from an LLM 119.

Referring now to FIG. 2, according to an embodiment, there is shown a system operation 200 that is performed when a user “clicks on” a type-1 “click to prompt button displayed at an e-commerce web site.

Step 1: A user 102 clicks on a type-1 “click to prompt” button 142 displayed at website 150.

Step 2: Embedded application 140 continuously monitors the type-1 “click to prompt” button 142 for engagement by the user 102.

Step 3: upon determining engagement by the user 102, user context data 137 is transmitted from a memory 134 of the user device 130 to the LLM 119 at the LLM platform 117.

Step 4: The LLM 119, processes the user context data 138, according to large language model processing techniques, to generate a user response transmitted to the chat interface 138 of the user device 130 to be viewed by the user 102.

In this embodiment, a key feature of automatically and transparently transmitting context data to the LLM from the user device is described at step 3. The context data informs the LLM about the product of interest to the user to provide an educated response when the user clicks on the associated clickable prompt button. Further, by passing the context data in the manner described, the user is removed from the need to describe the product to the LLM in a long-form query.

FIG. 3A, describes a system operation 300 that is performed when a user clicks on a type-2 “click to prompt” button displayed at an e-commerce web site.

Step 1: A user 102 clicks on the type-2 “click to prompt” button 142 at website 150.

Step 2: Embedded application 140 continuously monitors the type-2 “click to prompt” button 142 for engagement by the user 102.

Step 3: the LLM platform 117 is notified of a user 102 detection with the type-2 “click to prompt” button 142.

Step 4: the LLM platform 117, via a chat interface 138, requests user context data from the user 102 to enable generating an informed user response that is responsive to the detection of the user engagement with the type-2 “click to prompt” button 142.

Step 5: The user 102 passes the requested user context data to the LLM platform 117. At this step, in addition to passing the requested user context data, system context information is also passed to the LLM platform 117. The system context information 138 further informs the LLM 119 on how to respond to user requests and may include, in some embodiments, a Product ID, a current URL, a past browsing history of the user, a current browsing history of a user, items clicked on by the user. The past browsing history can include, for example, all of the web pages that the user has viewed during the browsing session, how long the user viewed each web page, whether the web page was scrolled by the user, the hyperlinks clicked on the web page, and the like. Step 6: The LLM platform 117 uses the customer context information and the system context information 138 to generate a complete response to the user.

FIG. 3B, describes a system operation when a user clicks on a type-2 “click to prompt” button displayed at an e-commerce web site to provide a user without assistance from an LLM 119.

Step 1: A user 102 clicks on the type-2 clickable prompt button 142 at website 150.

Step 2: Embedded application 140 monitors the user click of the type-2 clickable prompt button for detection by the user 102.

Step 3: Embedded application 140 notifies the clickable prompt button 142 that a user has clicked on (engaged) the clickable prompt button 142.

Step 4: Responsive to detection of the engagement, the type-2 “click to prompt” button 142 displays a follow up question to the user 302, via the chat interface 138.

Step 5: The user 102 provides a response to the follow up question in the chat interface 138.

### Example Method

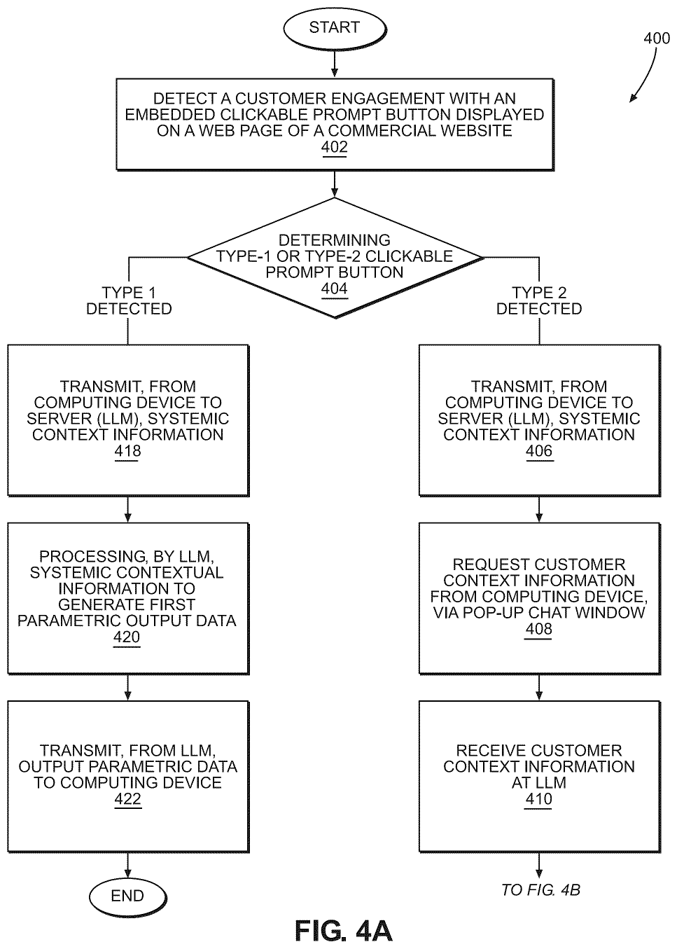

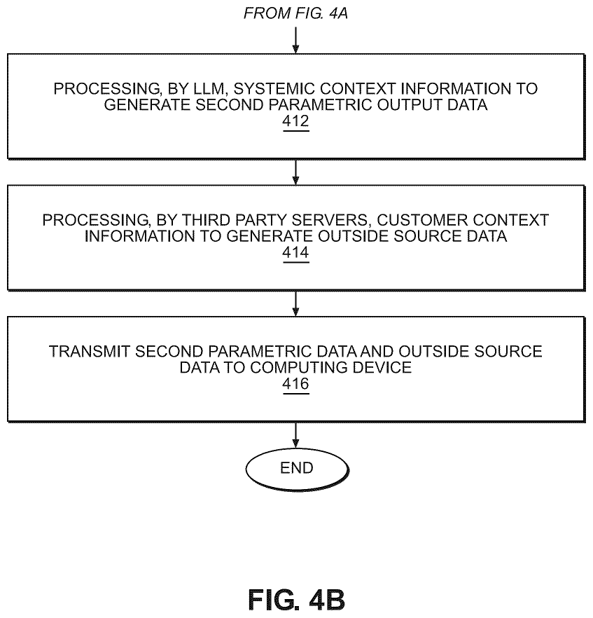

FIG. 4 is a flowchart of an example method 400 of the present disclosure pertaining to a method for engaging with an interactive large language model via an embeddable clickable prompt button. These steps may be performed by one or more general purpose processors of a mobile computing device or instead by one or more dedicated processors specifically suited to the functionality described herein.

At step 402, a clickable prompt button is embedded on a web page for display at a client-side computing device. As a non-limiting example, FIG. 5 shows clickable prompt buttons 512, 514, 516 being displayed at an e-commerce web page 500. The placement of the clickable prompt buttons is by a web designer. Clickable prompt buttons 512, 514, 516 are displayed in association with respective products X, Y and Z. As a further example, FIG. 6 shows clickable prompt buttons 604, 606, 608, 610 displayed in association with Product Y.

At step 404, a determination is made regarding what type of clickable prompt button has been engaged by a user at the web site. The clickable prompt buttons may be either type-1 or type-2. A type-1 clickable prompt button does not require that a large language model (LLM) make more than one information request from a user to obtain context information from the user regarding an item of interest to the user that is expressed when the user clicks on the item's associated clickable prompt button.

At step 406, upon determining that a clickable prompt button has been engaged by a user and that the button is a type-2 clickable prompt button, systemic context information is transparently transmitted from the user device 130 to an LLM 119 at a remote LLM platform 117. The systemic context information is preferably previously collected and stored by the client device prior to the transmission to the LLM platform 117.

At step 408, a pop-up chat window is shown to the user on the client-side device. An LLM 119 at the LLM platform 117 requests customer context information, which is different than the systemic context information discussed at step 406. The customer context information is transmitted to the LLM 119 via the pop-up chat window to provide the LLM 119 with additional context in responding to the user.

At step 410, the customer context information is received by the LLM 119 at the LLM platform 117.

At step 412, the systemic context information is processed by the LLM 119 to generate type-2 parametric output data.

At step 414, the customer context information is processed by one or more third party servers to generate outside source data.

At step 416, the type-2 parametric output data and the outside source data are transmitted to the client-side device as the user response. Notably, the user response is a compound response that relies on internal processing of the systemic context information by the LLM and external processing of the user context information by the one or more third party servers. The process terminates at this point.

At step 418, upon determining that a clickable prompt button has been engaged by a user and that the button is a type-1 clickable prompt button, systemic context information is transparently transmitted from the user device 130 to an LLM 119 at a remote LLM platform 117. The systemic context information is preferably previously collected and stored by the user device 130 prior to the transmission to the LLM platform 117.

At step 420, the LLM 119 processes the systemic context information to generate therefrom type-1 parametric output data.

At step 422, the type-1 parametric output data is transmitted to the user device 130 as a user response.

The following two examples further describe and explain important features and advantages provided by clickable prompt buttons.

### Example 1

FIG. 5 illustrates a system operation, by way of example, when a user clicks on a type-2 “click to prompt” button displayed at an e-commerce web site including assistance from an LLM.

FIG. 5 shows a webpage 500 of an exemplary e-commerce website displaying products X, Y and Z. A product Y is displayed in proximal and functional association with clickable prompt button 502, labeled “Ask a question”. When a user clicks on clickable prompt button 502, a user message, e.g., “I have a question about {{object.title}}, is automatically generated for insertion into a chat history even though the user did not actually type in the message (i.e., question). The object.title is one of the fixed fields that define clickable prompt button 502. In this example, the object.title=Product Y. As shown in FIG. 5, user messages are messages that are constructed by the system in response to a user clicking on a clickable prompt button 512 which are shown to the user in a chat history that communicatively couples the user and the remote interactive LLM 119. The user messages are passed to the interactive large language model (LLM) 119 to give the LLM context by making the LLM aware that the user just clicked on the clickable prompt button 512 and that a response is required. In furtherance of the instant example, upon receiving the message “I have a question about Product Y”, at the LLM, the LLM will generate a follow up question, “What is your question about {{object.title}} 504. This LLM's response is referred to herein as an AI message. In certain cases, AI messages are generated by the LLM to extract additional contextual information in the chat session.

### Example 2

The following example further highlights features and advantages provided by type-1 clickable prompt buttons that when clicked on, do not require follow up inquiries from an LLM.

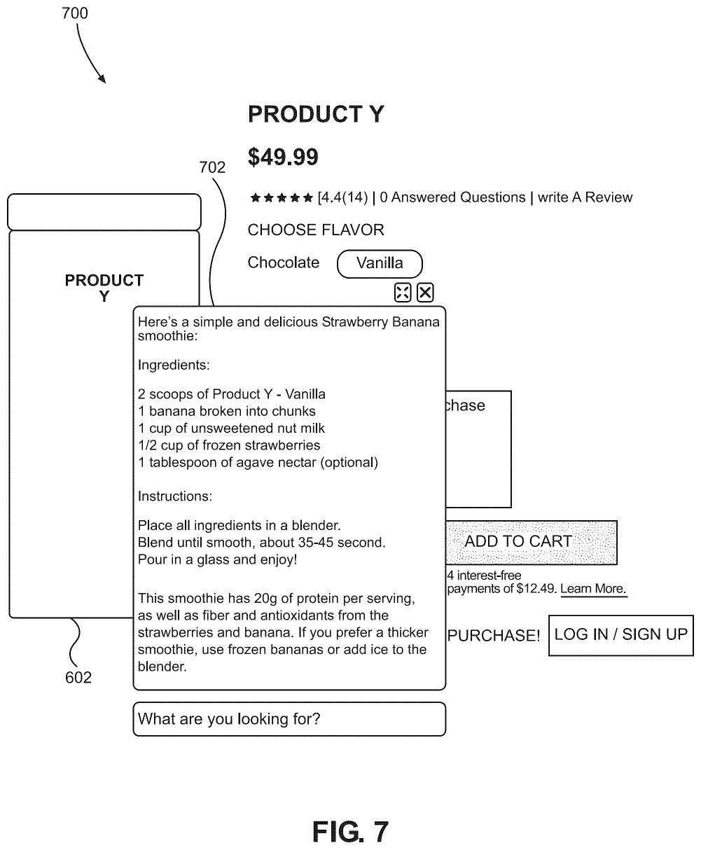

FIGS. 6 and 7 illustrate a system operation, by way of example, when a user clicks on a type-2 “click to prompt” button displayed at an e-commerce web site without assistance from an LLM.

FIGS. 6 and 7 show web pages 600, 700 of an exemplary e-commerce website displaying a single product Y 602. A user browsing the webpage 600, 700 may express an interest in the product Y 602. Web page 600, 700 includes four type-1 clickable prompt buttons 604, 606, 608, 610, uniquely labeled, “make a recipe” 604, “compare this” 606, “make a regimen” 608, and “ask a question” 610. Notably, type-1 clickable prompt buttons respond to user clicks by providing a user response independent of the assistance of a Large Language Model (LLM) or user provided contextual information. Instead, type-1 buttons are pre-programmed to provide user responses directly to users directly. For example, when a user clicks on the type-1 clickable prompt button 604, labeled, “make a recipe”, a recurring prompt 702 (i.e., recipe employing product Y, which may be a plant fuel) will be displayed to the user, as shown in FIG. 7. Notably, type-1 clickable prompt buttons may be advantageously employed at a website to satisfy frequently asked requests from users. For example, website statistics bear out that users often ask for recipes that can be prepared from displayed products on the website, hence the make a recipe” prompt is a recurring type-1 clickable prompt 702.

### Example 3

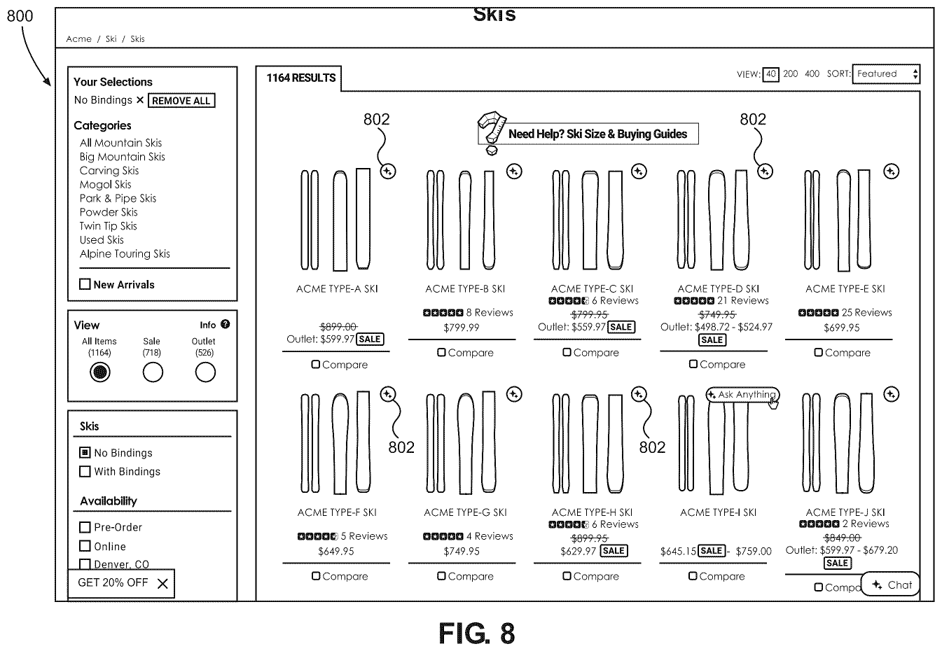

FIGS. 8-11 illustrate, by way of example, a system operation when a user clicks on a type-2 “click to prompt” button displayed at an e-commerce web site including assistance from an LLM, according to one embodiment.

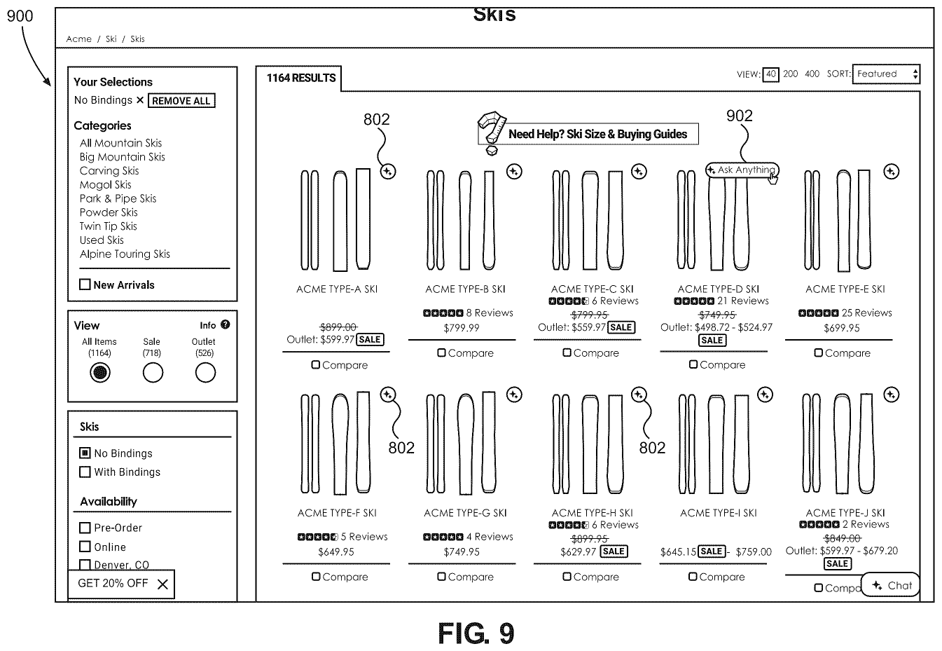

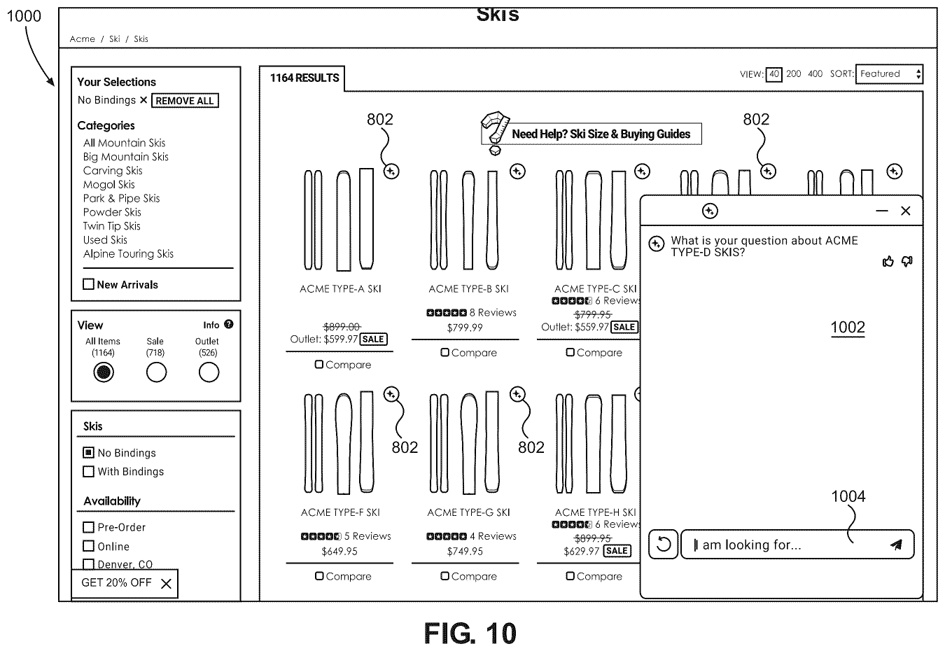

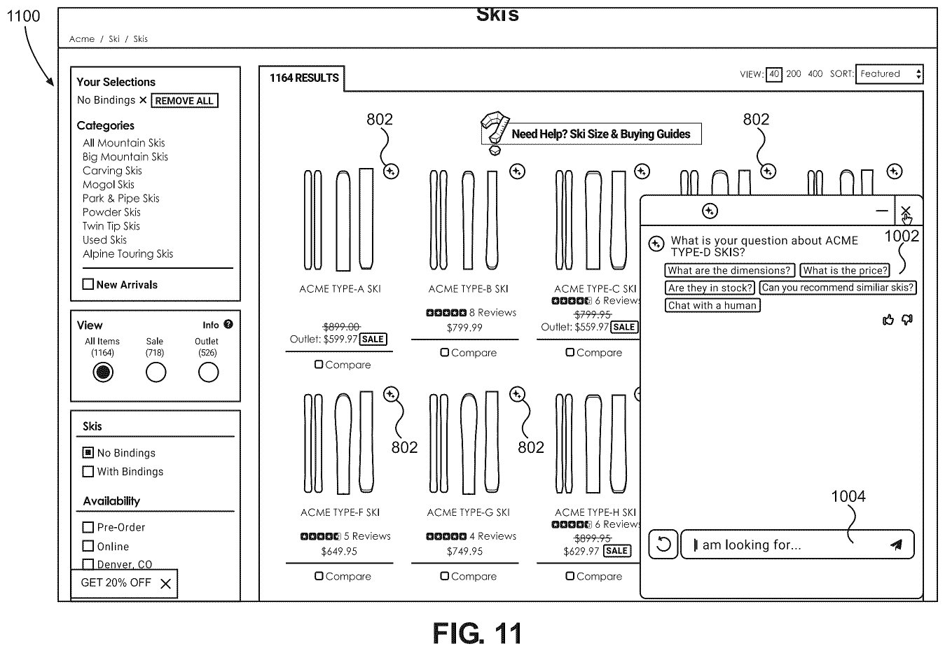

FIG. 8 shows a webpage 800 of an exemplary e-commerce website displaying a number of Acme ski products (e.g., ACME TYPE-A, ACME TYPE-B, . . . . ACME TYPE-J) The ACME ski products are displayed in association with the type-2 clickable prompt buttons 802 shown. In operation, when a user hovers over and clicks on a type-2 clickable prompt button 802 in association with one of the ACME ski products, the user, initiating the click action, is prompted by the system to “ask a question” 902, via the type-2 clickable prompt button 802, as shown in FIG. 9. When the user clicks on the “ask a question” 902 clickable prompt button, the user is shown a pop-up window 1002, as shown in FIGS. 10 and 11. The pop-up window 1002 prompts the user to ask a specific question about the product being inquired about in association with the clickable prompt button 802. The directed prompt states: “what is your question about Acme Type-D skis”. To prompt also includes five pre-canned questions that are typical questions commonly asked by users in making product inquiries. The user may respond to the system prompts in response bar 1004 of the pop-up window 1002.

In a further embodiment, the system may implement a specialized type of clickable prompt button, referred to herein as a Skill. Each skill functions as an automated agent displayed on a customer web page—an interactive digital assistant that performs specific functions without human intervention to enhance the shopping experience. These agents can answer questions, provide product information, guide purchasing decisions, and offer personalized recommendations in real-time, creating a conversational experience that mimics human assistance while maintaining consistent availability. The system can create any number of skills which can be placed anywhere the client chooses on the client website. This flexibility allows website owners to strategically position these interactive automated agents at optimal locations throughout the client's product pages to maximize customer engagement, provide contextual support at critical decision points, potentially reduce cart abandonment, increase conversion rates, and improve the overall shopping experience.

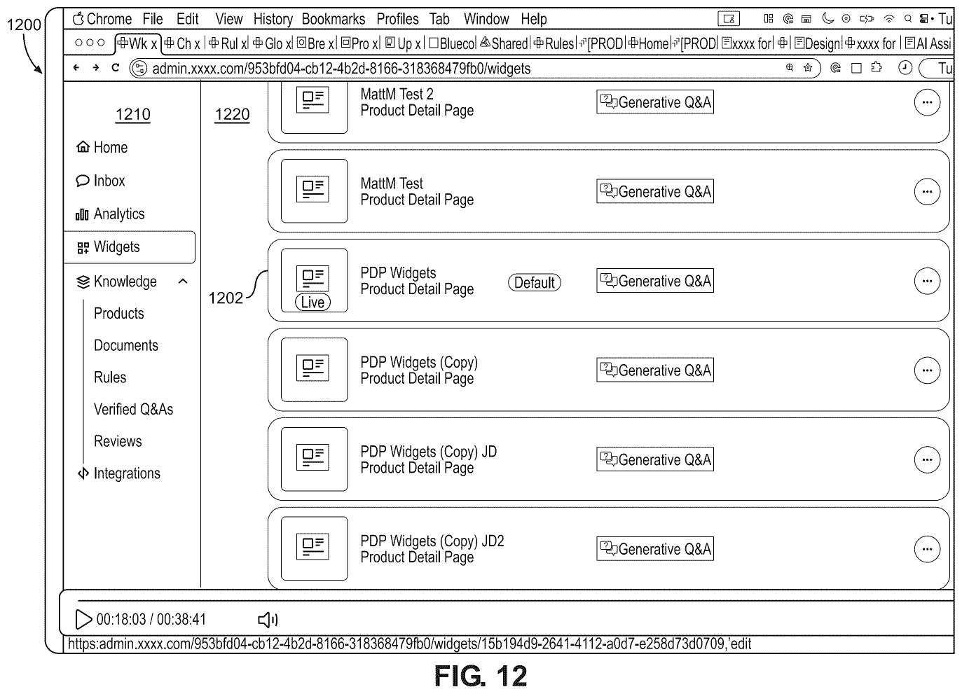

FIG. 12 illustrates a system interface screen 1200 of a system platform where a PDP Widget 1202 icon is displayed along with other user selectable options. The interface screen includes a left sidebar navigation menu 1210 and a main content area 1220 where there is shown several Product Detail Page items, with “PDP Widgets-Product Detail Page” marked as “Live” with a “Default” tag.

As illustrated in FIG. 12, the system interface screen 1200 enables the creation and management of multiple Widget instances, each represented as a separate entry in the widget management dashboard. These multiple entries (labeled as “PDP Widgets,” “PDP Widgets (Copy),” “PDP Widgets (Copy) JD,” etc.) represent distinct implementations of the same type of automated agent, each potentially configured with unique parameters, targeting rules, or behavioral characteristics while maintaining the core functionality of a PDP Widget. The proliferation of widget instances demonstrates the system's capacity for creating customized automated agents for deployment across various product pages or sections of an e-commerce website.

These widgets can be deployed across multiple sections of the e-commerce platform, including product category pages, search results, comparison tools, and throughout the client's product pages. Each widget instance maintains consistent functionality while being customizable to specific product contexts, ensuring that customers receive relevant assistance regardless of their entry point into the shopping experience. This strategic positioning enables website owners to maximize customer engagement, provide contextual support at critical decision points, potentially reduce cart abandonment, increase conversion rates, and improve the overall shopping experience. The system's adaptability provides seamless support throughout the entire customer shopping experience, from initial product discovery to final purchase decision.”

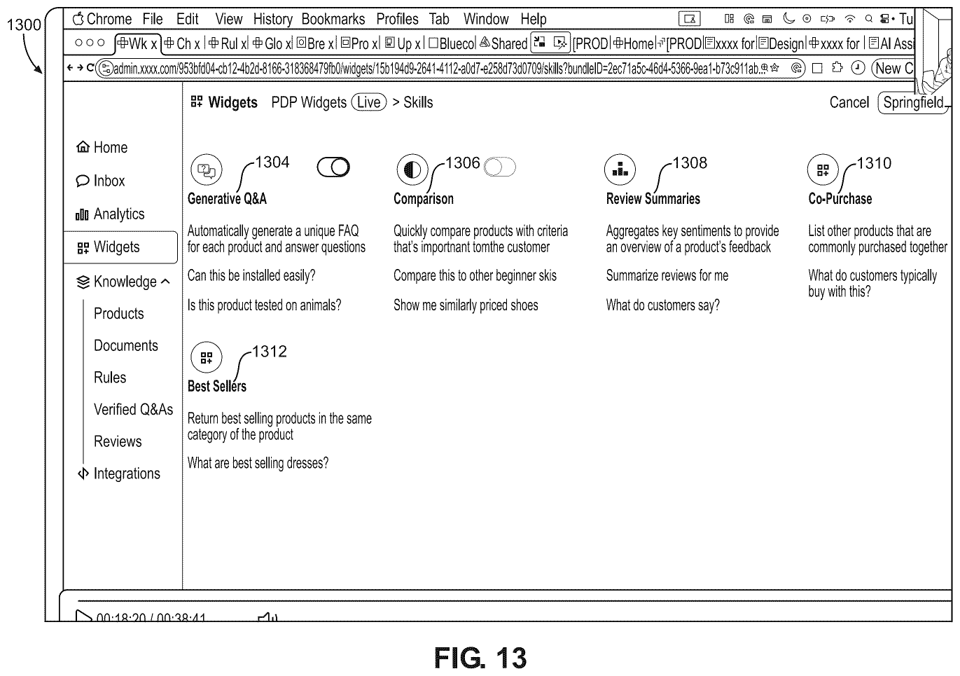

FIG. 13 illustrates an interface screen 1300 displayed to the user upon selecting the PDP Widgets 1202 icon option from the system interface screen 1200 shown in FIG. 12. This interface screen 1300 displays various automated widgets 1304, 1306, 1308, 1310, 1312 available for use on Product Detail Pages of a website. Each widget shown in FIG. 13 is represented with a distinct icon and has an associated toggle switch to enable/disable the widget. This interface screen 1300 allows a website owner to configure which automated widgets will be available on their product detail pages.

The automated Widgets displayed in FIG. 13 are comprised of a Generative Q&A widget and one or more skills. The Generative Q&A widget 1304 is used to generate a standard button on one or more product detail pages of a customer's website. Standard buttons include Type-1 and Type-2 buttons, as described above. Skills (1306, 1308, 1310, 1312) differ from Generative Q&A widgets and are comprised of specific functions, actions, and data dependencies, as further described below with reference to Table I.

In one aspect, skills operate similarly to an API in the sense that a Skill can ping external systems to request and retrieve information. For example, a Skill might ping a customer review database to get customer reviews, ping a product catalog database to get comparable products to the ones being purchased, ping an inventory database to check real-time product availability, or ping a sales transaction database to get top selling products within the same product category as the one being purchased. In each case, the Skill initiates a request (ping) to an external system, waits for the response, and then utilizes the returned data to perform its unique designated function within the customer's website.

To further illustrate the functionality and implementation of the Skills, Table I provides some exemplary Skills as one might use in a particular embodiment. Each Skill in Table I is defined by its skills name, specialized primary function, specific action performed when activated, and the external data source upon which it depends for operation. Other embodiments may include more or less skills having the same or different functionality. This categorization enables website owners to select and implement the most appropriate Skills based on their specific e-commerce requirements and available data resources.

TABLE I

| | | | DATA |
|---|---|---|---|
| SKILLS | FUNCTION | ACTION | DEPENDENCY |
| Review | Analyze | Generate | Customer |
| Summaries | customer | condensed | review database |
| | feedback | overviews of | |
| | | customer reviews | |
| Product | Identifies | Suggests | Product |
| Comparison | similar | comparable items | Catalogue |
| | or alternative | based on current | database with |
| | products | product selection | detailed |
| | | | specifications |
| Co-purchase | Tracks | Displays items | Purchase history |
| recommendations | purchasing | frequently bought | database |
| | patterns | together with | |
| | | selected product | |
| Best Sellers | Monitors sales | Lists top-selling | Sales |
| | performance | products within | transaction |
| | | the same category | database |

The following sections provide a more detailed examination of the exemplary Skills shown in Table I, including implementation examples, user engagement patterns, and the technical processes that enable their functionality within an e-commerce environment.

Review Summaries skill—As shown in Table 1, this skill's primary function is to analyze customer feedback. Its action involves generating condensed overviews of customer reviews when the user engages the widget. Example button prompts may include, for example, “Summarize reviews for me” and “What do customers say?” This skills widget has a data dependency on a customer review database, which an LLM analyzes to extract key sentiments and provide meaningful summaries to a shopper.

Product Comparison skill—As shown in Table 1, this skill's primary function is to identify similar or alternative products. Its action involves suggesting comparable items based on the current customer product selection when the customer engages the widget. Example button prompts include, for example, “Compare this to other beginner skis” and “Show me similarly priced shoes.” This skill has a data dependency on a product catalog database with detailed specifications, allowing an LLM to make accurate comparisons between products.

Co-purchase Recommendations skill—As shown in Table 1, this skill's function is to track purchasing patterns. Its action involves displaying items frequently bought together with the selected product when the user engages the skill. Example button prompts include, for example, “What do customers typically buy with this?” This skills widget has a data dependency on a purchase history database, which an LLM uses to identify meaningful product associations.

Best Sellers widget—As shown in Table 1, this skill's function is to monitor sales performance. Its action involves listing top-selling products within the same category when the customer engages the skill. Example prompt buttons may include, for example, “What are best selling dresses?” This skill has a data dependency on a sales transaction database, which an LLM uses to identify and rank products by popularity.

As clearly shown in Table 1, each skill has a distinct function (e.g., what the skill monitors or analyzes), action (e.g., what the skill generates or displays when engaged), and data dependency (e.g., the database the skill requires to function properly).

In operation, when a customer engages with one of the skills, the system performs a dual-channel data retrieval and processing operation. First, the system transmits relevant contextual information to the interactive large language model (LLM), which serves as the analytical engine for the automated skills agent. Simultaneously, the system initiates a data retrieval request to the specific external database associated with the particular skill. The LLM then processes both the contextual information and the retrieved database information to generate a tailored response. For example, when a customer engages with the Review Summaries skill, the system accesses the customer review database to retrieve the raw review data, which is then sent to the LLM along with contextual information about the product and user interaction, enabling the LLM to generate a condensed, relevant overview of customer feedback. Similarly, when a customer engages with the Co-purchase skill, the system accesses the purchase history database to retrieve co-purchasing patterns, which the LLM analyzes in conjunction with the current product context to identify and recommend the most relevant frequently co-purchased items.

The addition of these specialized skills enhances the functionality of the clickable prompt buttons system described above by providing tailored product information that assists customers in making informed purchase decisions, thereby improving the overall browsing and shopping experience. More particularly, the function-action-data dependency structure of these skill enables a highly efficient and targeted information delivery system that addresses specific customer needs without requiring extensive manual searching or comparison.

A significant advantage of employing the skills is that website owners can add any number of these skills and position them anywhere on their website. This allows for customized implementation based on the specific needs of different product categories, page layouts, or customer segments. For example, a clothing retailer might place the “Co-purchase Recommendations” skill prominently on product pages for outfit coordination, while an electronics retailer might prioritize the “Product Comparison” skills to help customers evaluate technical specifications. The system's flexibility in skills placement and quantity contributes substantially to its effectiveness in enhancing the customer shopping experience across diverse e-commerce environments.

### Prompt Generation Subsystem (PGS)

The PGS system necessarily incorporates a prompt generation subsystem (PGS) as the hardware architecture for carrying out the functionality of the skills described previously. This PGS subsystem dynamically creates and refines prompts based on actions taken by users interacting with the skills, leveraging large language model (LLM) technology similar to that described for generating dynamic frequently asked questions (FAQs), as described in U.S. Pat. No. 18,589,343, incorporated by reference herein in its entirety.

### System Architecture

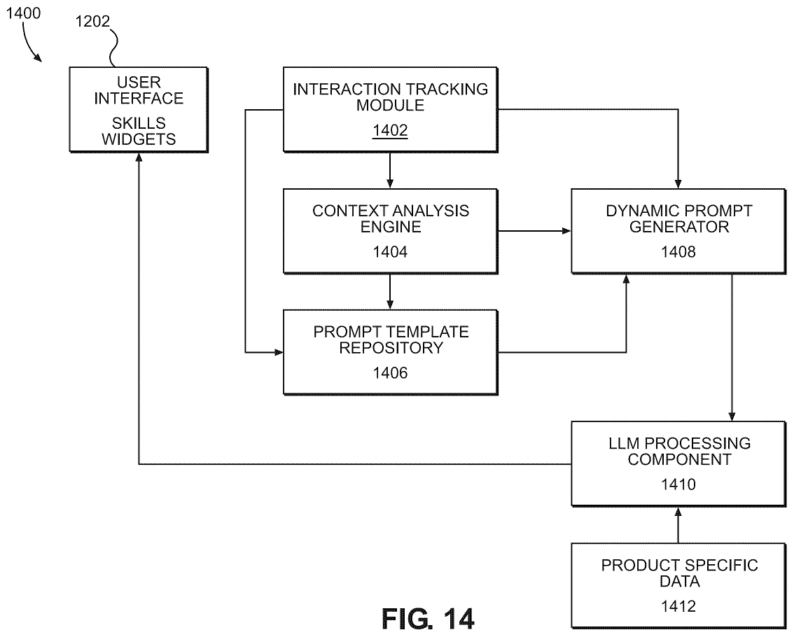

FIG. 14 illustrates the architecture of the Prompt Generation Subsystem 1400 and its relationship with the skills described previously. The subsystem comprises an Interaction Tracking Module 1402, a Context Analysis Engine 1404, a Prompt Template Repository 1406, and a Dynamic Prompt Generator 1408, all operating in conjunction with an LLM processing component 1410 trained on product-specific data 1412.

The Prompt Generation Subsystem 1400 is designed to work in conjunction with the previously described Skills, which serve as the customer-facing interface elements on product detail pages. As defined in Table I above, these Skills may include, in one embodiment, elements such as Review Summaries, Product Comparison, Co-Purchase Recommendation, and Best Sellers skills, each providing specific product-related functionality to customers. The PGS Subsystem 1400 enhances these Skills by analyzing customer interactions, determining user preferences and needs, and dynamically generating contextually relevant prompts that appear as additional clickable elements. This integration transforms the Skills from static tools into components of an intelligent, adaptive shopping guidance system. The detailed relationship between each PGS component and the Skills is further explained in the following sections.

### Detailed Component Description of PGS Sub-System Architecture

### Interaction Tracking Module

The Interaction Tracking Module 1402 functions similarly to the conversation agent described in the FAQ system of U.S. Pat. No. 18,589,343, recording all user interactions with the skills. In some embodiments, when a customer engages with a skills, such as clicking on a “Summarize reviews” button or using the “Product Comparison” button, the Interaction Tracking Module 1402 captures several data points, including: (1) the specific skill type activated, (2) the timing and sequence of skill activations, (3) the product context in which the skill was activated, and (4) any selections or refinements made by the customer during the skill interaction. These data points are described as follows.

(1) The specific skill type activated: This identifies which of the skills the customer has engaged with, whether it's the Review Summaries, Product Comparison, Co-Purchase Recommendation, or Best Sellers skill. Each skill type triggers different data collection parameters and processing pathways.

(2) The timing and sequence of skill activations: This temporal data records not only when each skill was activated but also the chronological order of multiple skill interactions within a single browsing session. This sequential information reveals the customer's decision-making progression and helps identify patterns in how customers navigate between different information sources during their shopping process.

(3) The product context in which the skill was activated: This encompasses metadata about the product being viewed when the skill was activated, including the product category, price point, brand, technical specifications, and position within the catalog hierarchy. This contextual information enables the system to tailor subsequent prompts to the specific product domain and customer segment.

(4) Any selections or refinements made by the customer during the skill interaction: This captures all choices made within each skill, such as which specific product attributes were prioritized during comparison, which sentiment categories were explored in reviews, which price filters were applied to best sellers, or which complementary items were considered in co-purchase recommendations. These selection patterns provide insight into the customer's specific preferences and purchase criteria.

### Context Analysis Engine

The Context Analysis Engine 1404 processes the interaction data collected by the Interaction Tracking Module 1402 to determine the customer's implied needs and interests. This component employs pattern recognition algorithms similar to those used in the scoring means as described in the FAQ system of U.S. Pat. No. 18,589,343. The Context Analysis Engine 1404 analyzes various collected interaction data including, by way of example and not limitation, browsing behavior, click patterns, engagement metrics, etc. to identify shopping behaviors and preference indicators, in a manner similar to how the FAQ system of U.S. Patent Application No. 18,589,343 determines the optimal subset of questions to display.

In an embodiment, the Context Analysis Engine 1404 functions through several key mechanisms:

(1) Behavioral Pattern Recognition: The context analysis engine 1404 recognizes how customers shop by watching which buttons they click and in what order. It then places shoppers into common categories. For example, if someone spends a lot of time comparing camera features and specifications, the system labels them as a “feature-driven comparison shopper.” If another person mostly reads customer reviews, they're identified as a “review-focused researcher.

In some embodiments, the Context Analysis Engine 1404 may implement multi-dimensional cluster analysis to classify customer interaction patterns into discrete behavioral segments. The system may employ supervised machine learning algorithms to analyze sequential interaction data, including skill activation frequency, dwell time between interactions, and hierarchical navigation paths. For example, when a customer exhibits a pattern of extended engagement with technical specification comparisons across multiple products, the system algorithmically classifies them within the “feature-driven comparison shopper” segment with an associated confidence score. Conversely, customers demonstrating prolonged engagement with user-generated content are classified into the “review-focused researcher” segment, with each classification triggering distinct prompt template selection logic.”

(2) Intent Inference: The context analysis engine 1404 makes educated guesses about what the customer is trying to accomplish based on their actions on the website. It looks at which buttons they click and what options they select. For example, if someone keeps checking battery life details while looking at smartphones, the system understands that battery performance is important to that customer In some embodiments, the context analysis engine 1404 may employ a probabilistic inference model to computationally determine customer objectives based on captured interaction signals. The system may utilize a Bayesian network that calculates conditional probabilities between observed actions and likely purchase criteria. For instance, when a customer repeatedly accesses battery performance metrics across multiple smartphone listings, the system calculates a statistically significant correlation between this interaction pattern and prioritization of battery performance as a decision criterion. The inference model incorporates both explicit signals (direct interactions) and implicit signals (navigation patterns, comparative viewing sequences) to generate a weighted hierarchy of inferred purchase criteria.

(3) Contextual Relevance Scoring: The context analysis engine 1404 ranks possible follow-up questions based on what would be most helpful to the shopper right now. For example, if a customer is comparing how many cups different coffee makers can brew, the system will suggest questions about capacity differences or which size works best for different households, instead of less helpful questions about colors or minor features. In some embodiments, the context analysis engine 1404 may implement a multi-factor scoring algorithm that quantitatively ranks potential follow-up prompts based on calculated utility value to the customer's current decision process. The scoring function incorporates variables including: (i) statistical correlation between the prompt content and the customer's demonstrated interests (weighted at 0.4), (ii) historical conversion rate when similar prompts were presented in analogous contexts (weighted at 0.3), and (iii) information entropy reduction potential of the prompt's associated response (weighted at 0.3). For example, when analysis indicates a customer is evaluating coffee maker brewing capacity, the algorithm assigns significantly higher relevance scores to prompts addressing quantitative capacity comparisons (scoring 0.85+) versus aesthetically-focused prompts (scoring 0.35 or lower), thereby optimizing the information presentation for maximum decision-making utility.”

(4) Decision Point Identification: By analyzing typical customer process, the engine identifies critical decision points where additional information or guidance would most benefit the customer. This timing optimization ensures prompts appear at moments of maximum utility. For example, when a customer pauses on a product page after examining several similar items, the system might trigger a comparison prompt, or when a user adds an item to their cart, the system may suggest commonly purchased accessories that enhance the product's functionality

### Prompt Template Repository

The Prompt Template Repository 1406 contains a comprehensive collection of prompt templates categorized by: (1) skill type, (2) detected customer intent, (3) product category, and (4) stage in the customer process. These templates are structured with variable placeholders that can be populated with specific product information, customer preferences, and contextual data, similar to the pre-configured prompts as described in the FAQ system of U.S. Patent Application No. 18,589,343.

The Prompt Template Repository 1406 serves as a centralized database of customizable message templates that enable the PGS sub-system to generate contextually relevant interactions with customers. It receives inputs from two primary sources: the Context Analysis Engine 1404 and the Interaction Tracking Module 1402. From the Context Analysis Engine 1404, it obtains information about the customer's shopping behavior category (such as “feature-driven comparison shopper”), their inferred intent (like concerns about battery life), and their current decision point in the shopping process. From the Interaction Tracking Module 1402, it receives data about which specific skills the customer has used and what product they're currently viewing. The Prompt Template Repository 1406 then outputs to the Dynamic Prompt Generator 1408 by providing appropriate template structures that match the current context, which can then be customized with specific product information and customer preferences to create personalized interactions.

The Prompt Template Repository 1406 performs three major functions within the system architecture.

First, the repository 1406 handles template storage and organization, maintaining a comprehensive library of prompt templates that are categorized by (a) skill type, such as review summaries or product comparison, (b) customer intent, including feature comparison and price sensitivity, product category, and (c) stage in the customer process. For example, the repository might store templates like “What do customers say about the {feature focus} of this {product_name}?” for Review Summaries skills when customers show quality assurance intent. As a further example, for product comparison skills, the repository might store templates like, “How does this {product_name} compare to other {product category} in terms of {comparison attribute}?”.

Second, the repository 1406 manages variable placeholders, containing templates with dynamic fields like {product_name} and {feature_focus} that enable personalization of messaging for each customer interaction. These placeholders can be populated with specific values such as “Sony A7III Camera” for {product_name} or “low-light performance” for {feature_focus}, creating tailored prompts like “What do customers say about the low-light performance of this Sony A7III Camera?”

Third, the repository 1406 facilitates contextual matching, helping the system select the most appropriate messaging format based on the customer's position in their shopping process and their apparent interests. For example, when a customer is actively comparing technical specifications across multiple laptops, the system might select a template focused on performance differentiation, while a customer exploring customer reviews might receive a template designed to highlight specific user experiences related to their browsing pattern. This contextual awareness ensures that prompts remain relevant to the customer's current decision-making process. To illustrate this function in action, consider a customer shopping for a digital camera who initially uses the Product Comparison skill to compare features between three different models, spending significant time examining sensor size and megapixel specifications. The Prompt Template Repository would recognize this behavior pattern as characteristic of a technically-oriented comparison phase and might select a template such as “Would you like to see a side-by-side comparison of low-light performance tests for these camera models?” Later, if the same customer shifts to activating the Review Summaries widget for one specific camera model, the repository would detect this transition to a validation phase and might instead select a template such as “Are you interested in seeing what professional photographers say about this camera's performance in landscape photography?” By dynamically adjusting template selection based on these contextual signals, the system creates a conversation flow that naturally follows the customer's evolving decision process rather than presenting disconnected or generalized prompts.

In the larger scope of the system, the Prompt Template Repository 1406 bridges the critical gap between understanding customer behavior (a function handled by the Context Analysis Engine 1404) and generating personalized, helpful communications (performed by the Dynamic Prompt Generator 1408). It essentially transforms raw customer data and behavioral insights into structured communication frameworks that can be customized to create natural, relevant interactions through the PDP Widgets. Through these functions, the Prompt Template Repository 1406 ensures consistency in how the system communicates while allowing for the flexibility needed to address specific customer needs across different shopping contexts

### Prompt Template Repository Management

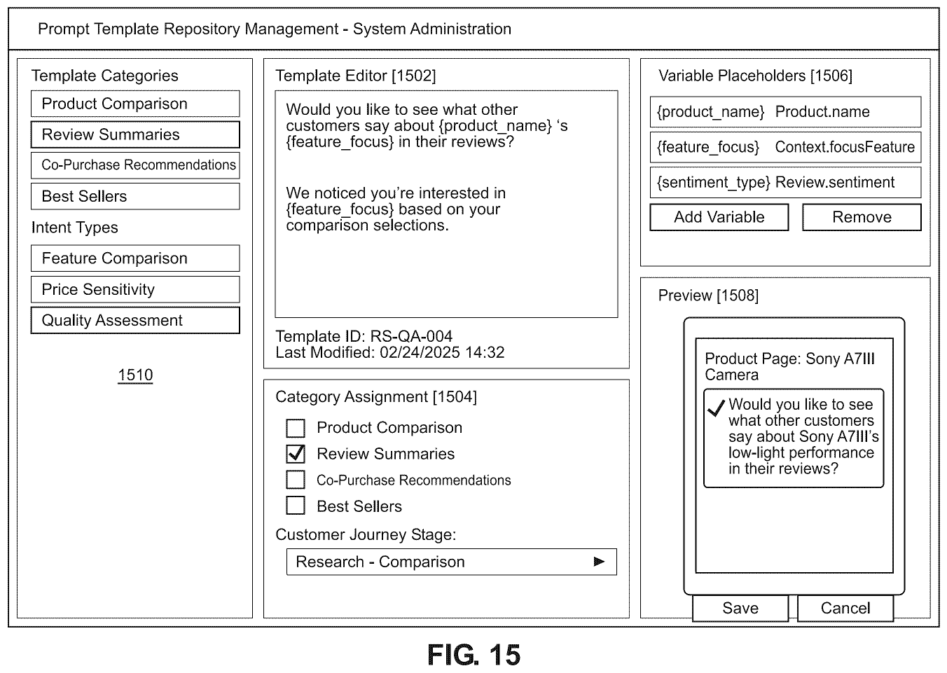

FIG. 15 illustrates the interface screen 1500 where system administrators can configure and manage the Prompt Template Repository 1406. The interface includes a template editor 1502, category assignment options 1504, variable placeholder definitions 1506, and a preview panel 1508 showing how the template would appear in different contexts.

To facilitate comprehensive prompt template administration, the management interface comprises four primary functional sections, each designed to address a specific aspect of template creation and deployment:

(1) a template editor section 1502, showing a sample prompt template with variable placeholders for product names and feature focus. It includes template metadata like ID and modification date.

(2) a category assignment option section 1504, displaying checkboxes for assigning the template to different skill types (Product Comparison, Review Summaries, etc.) and a dropdown for selecting the customer process stage.

(3) a variable placeholder definitions section 1506, showing placeholders like {product_name} and {feature_focus} with their corresponding data sources.

(4) a preview panel section 1508, displaying how the template would appear in a mobile device context with a specific example (Sony A7III Camera) and its low-light performance reviews.

The management interface also includes a navigation panel 1510 on the left showing template categories and intent types, similar to the FAQ management interface of U.S. Pat. No. 18,589,343. The design follows a typical enterprise management console layout with clear labeling of the key components mentioned in the specification.

### Dynamic Prompt Generator

The Dynamic Prompt Generator 1408 is the core component that combines data from the Interaction Tracking Module 1402, Context Analysis Engine 1404, and Prompt Template Repository 1406 to create contextually relevant prompts in real-time. This component selects the most appropriate prompt template based on the customer's interaction pattern and populates it with specific details relevant to the customer's current context, similar to how the LLM in the FAQ system generates follow-up questions based on initial queries.

For example, if a customer uses the Product Comparison widget to compare different laptop models, focusing primarily on processing speed and memory specifications, and then proceeds to engage with the Review Summaries widget, the Dynamic Prompt Generator 1408 might generate a follow-up prompt such as: “Would you like to see what customers say specifically about the performance of this laptop under heavy workloads?”

The PGS sub-system 1400 can be configured to generate an initial set of at least one product-related prompt for each skill using the context information for each product listed on the ecommerce store. When the customer interacts with a skill, the system prepares a contextual response using a pre-configured prompt, the skill interaction data, and the information regarding the product stored in the source database. It then generates and displays the response along with predicted follow-up prompts that appear as Type-1 or Type-2 clickable buttons, creating a seamless, conversational shopping experience that guides customers through their product discovery process.

This integration of skills with a prompt generation sub-system 1400 represents a significant advancement over traditional e-commerce navigation systems. By leveraging the same LLM technology used for dynamic FAQ generation, the system transforms individual skills from standalone tools into components of an integrated, intelligent shopping guidance system that adapts to each customer's unique decision-making process and browsing behavior, similar to how the FAQ system described in U.S. Pat. No. 18,589,343, adapts to individual customer browse patterns.

The Skills form the crucial interface layer that connects customers with the sophisticated Prompt Generation Subsystem 1410, creating a seamless information flow that enhances the shopping experience. Skills serve as the primary touchpoints for customers on product pages, functioning as entry points for interaction when customers click on a skill like Review Summaries, Product Comparison, Co-purchase recommendations, or Best Sellers. These interactions initiate the entire information flow through the system.

Each customer engagement with a skill triggers the Interaction Tracking Module 1402, which captures detailed data about which skill was used, when it was activated, what product was being viewed, and any specific selections the customer made during the interaction. The Context Analysis Engine 1404 then processes these skill interactions to identify patterns and infer customer intent, classifying shopping behavior based on which Skills the customer uses and in what sequence. This behavioral analysis informs the selection of appropriate templates from the Prompt Template Repository 1406, which contains templates specifically designed for each skill type. The Dynamic Prompt Generator 1408 subsequently combines the selected template with specific product data and customer preferences, while the LLM Processing Component 1410 processes this information to generate the actual content displayed through the Skills.

This creates an iterative loop where customer interactions with a skill responses feed back into the Interaction Tracking Module 1402, enabling continuous system learning and improvement. In essence, Skills function both as input mechanisms that capture customer intentions through interactions and as output channels that deliver personalized assistance, serving as the customer-facing components that enable the behind-the-scenes intelligence to provide relevant, contextual shopping assistance.”

In addition to the web-based implementation, the Skills system extends its functionality to email communications with customers. When the system detects opportunities for customer engagement, such as abandoned shopping carts, it can generate emails containing embedded Skills that function similarly to those on product pages. These email-based Skills serve as interactive touchpoints that prompt customer re-engagement outside the website environment. For example, an automated cart abandonment email might include a message such as “You left this product in your cart, do you have any questions?” followed by a series of clickable prompts representing the same Skills available on the website (e.g., Review Summaries, Product Comparison, Co-purchase Recommendations, and Best Sellers). When a customer clicks on one of these email-embedded widgets, they are directed to a dedicated landing page where the system immediately displays the relevant response to their specific query. This seamless transition from email to website maintains the conversational shopping experience and allows the system to continue tracking customer interactions through the Interaction Tracking Module 1402, even when the initial engagement occurs outside the website environment

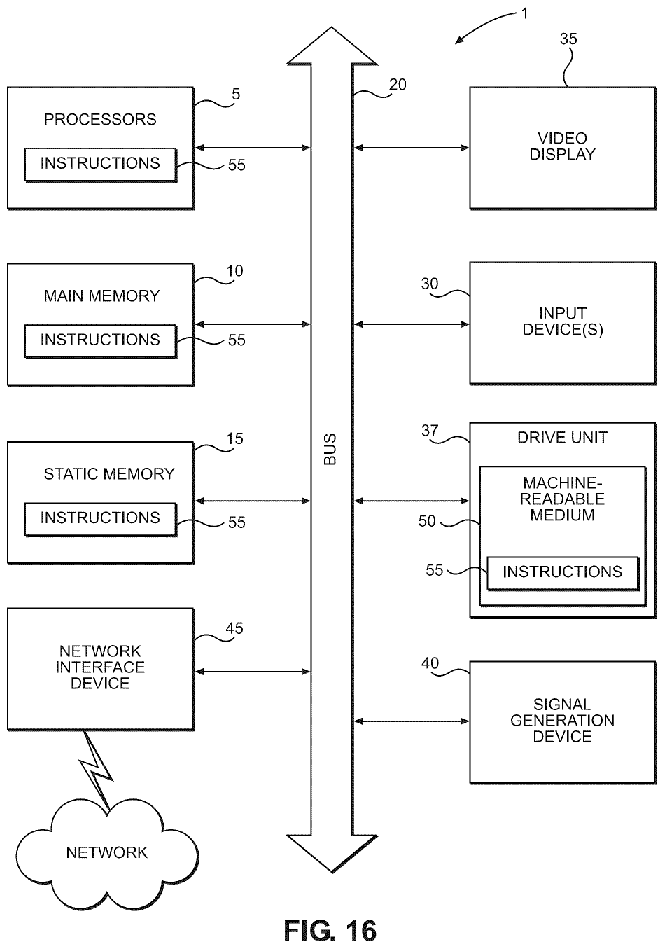

FIG. 16 is a diagrammatic representation of an example machine in the form of a computer system 1, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be an Internet-of-Things device or system, a personal computer (PC), a tablet PC, a set-top box (STB), a personal digital assistant (PDA), a cellular telephone, a portable music player (e.g., a portable hard drive audio device such as a Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 1 includes a processor or multiple processor(s) 5 (e.g., a central processing unit (CPU), a graphics processing unit (GPU), or both), and a main memory 10 and static memory 15, which communicate with each other via a bus 20. The computer system 1 may further include a video display 35 (e.g., a liquid crystal display (LCD)). The computer system 1 may also include an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 1 may further include a data encryption module (not shown) to encrypt data.

The drive unit 37 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within the processor(s) 5 during execution thereof by the computer system 1. The main memory 10 and the processor(s) 5 may also constitute machine-readable media.

The instructions 55 may further be transmitted or received over a network via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

The components provided in the computer system 1 of FIG. 16 are those typically found in computer systems that may be suitable for use with embodiments of the present disclosure and are intended to represent a broad category of such computer components that are well known in the art. Thus, the computer system 1 can be an Internet-of-Things device or system, a personal computer (PC), hand held computer system, telephone, mobile computer system, workstation, tablet, phablet, mobile phone, server, minicomputer, mainframe computer, wearable, or any other computer system. The computer may also include different bus configurations, networked platforms, multi-processor platforms, and the like. Various operating systems may be used including UNIX, LINUX, WINDOWS, MAC OS, PALM OS, QNX ANDROID, IOS, CHROME, TIZEN, and other suitable operating systems.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the technology. Those skilled in the art are familiar with instructions, processor(s), and storage media.

In some embodiments, the computer system 1 may be implemented as a cloud-based computing environment, such as a virtual machine operating within a computing cloud. In other embodiments, the computer system 1 may itself include a cloud-based computing environment, where the functionalities of the computer system 1 are executed in a distributed fashion. Thus, the computer system 1, when configured as a computing cloud, may include pluralities of computing devices in various forms, as will be described in greater detail below.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud is formed, for example, by a network of web servers that comprise a plurality of computing devices, such as the computer device 1, with each server (or at least a plurality thereof) providing processor and/or storage resources. These servers manage workloads provided by multiple users (e.g., cloud resource customers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications, as well as wireless communications (both short-range and long-range). Common forms of computer-readable media include, for example, a floppy disk, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASHEPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The foregoing detailed description includes references to the accompanying drawings, which form a part of the detailed description. The drawings show illustrations in accordance with exemplary embodiments. These example embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is, therefore, not to be taken in a limiting sense, and the scope is defined by the appended claims and their equivalents.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the invention in the form disclosed. Many modifications and variations will be apparent to those of ordinary skill in the art without departing from the scope and spirit of the invention. Exemplary embodiments were chosen and described in order to best explain the principles of the present technology and its practical application, and to enable others of ordinary skill in the art to understand the invention for various embodiments with various modifications as are suited to the particular use contemplated.

While various embodiments have been described above, it should be understood that they have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the technology as defined by the appended claims. Thus, the breadth and scope of a preferred embodiment should not be limited by any of the above-described exemplary embodiments.

What is claimed is:

1. A computer-implemented method for providing interactive product information, the method comprising:
generating a plurality of skills for display on a product detail page of an e-commerce website, each skill comprising a clickable prompt button that performs a specific function to provide product-related information to a user viewing the e-commerce website;
tracking, via an interaction tracking module, user interactions with the plurality of skills,
analyzing, via a context analysis engine, the tracked user interactions to identify user preferences;
selecting prompt templates from a prompt template repository based on the analyzed user interactions;
generating, via a dynamic prompt generator in communication with a large language model (LLM), contextually relevant prompts in real-time based on the analyzed user interactions and the selected prompt templates; and
upon user activation of a skill, displaying the generated contextually relevant prompts as additional clickable prompt buttons on the product detail page, the additional clickable prompt buttons enabling the user to initiate follow-up queries related to the product without requiring manual text entry, each additional clickable prompt button, when activated, triggering the generation of new contextually relevant prompts based on the user's ongoing interaction with the product detail page.

2. The method of claim 1, wherein the product-related information provided to the user viewing the e-commerce website comprises at least one of: (i) condensed overviews of customer reviews generated by analyzing a customer review database, (ii) comparable product suggestions based on current product selection obtained from a product catalog database, (iii) items frequently bought together with a selected product derived from a purchase history database, and (iv) top-selling products within a same category accessed from a sales transaction database.

3. The method of claim 1, wherein tracking user interactions with the plurality of skills comprises recording: (i) a specific skill type activated, (ii) timing and sequence of skill activations, (iii) product context in which a skill was activated, and (iv) selections made by a user during skill interaction.

4. The method of claim 1, wherein analyzing the tracked user interactions comprises determining user implied needs and interests.

5. The method of claim 1, wherein the prompt template repository contains prompt templates categorized by skill type, detected user intent, product category, and stage in customer process.

6. The method of claim 1, wherein generating the contextually relevant prompts comprises: (i) retrieving relevant product data from at least one external database associated with an activated skill; (ii) combining the retrieved product data with a user's interaction context; and (iii) processing the combined data through the LLM to generate the contextually relevant prompts.

7. The method of claim 1, wherein the additional clickable prompt buttons are dynamically prioritized and reordered based on their predicted relevance to the user's current context and previous interactions.

8. The method of claim 1, further comprising caching responses to frequently activated prompts to reduce response time for common queries without requiring repeated LLM processing.

9. The method of claim 1, further comprising determining an optimal number of additional clickable prompt buttons to display based on the user's device type, screen size, and historical engagement metrics.

10. The method of claim 1, wherein the skills and the additional clickable prompt buttons are visually differentiated to indicate their distinct functions to the user.

11. A system for providing interactive product information, comprising:
a processor;
a memory storing instructions that, when executed by the processor, cause the system to perform operations comprising:
generating a plurality of skills for display on a product detail page of an e-commerce website, each skill comprising a clickable prompt button that performs a specific function to provide product-related information to a user viewing the e-commerce website;
tracking, via an interaction tracking module, user interactions with the plurality of skills;
analyzing, via a context analysis engine, the tracked user interactions to identify user preferences;
selecting prompt templates from a prompt template repository based on the analyzed user interactions;
generating, via a dynamic prompt generator in communication with a large language model (LLM), contextually relevant prompts in real-time based on the analyzed user interactions and the selected prompt templates; and
upon user activation of a skills widget, displaying the generated contextually relevant prompts as additional clickable prompt buttons on the product detail page, the additional clickable prompt buttons enabling the user to initiate follow-up queries related to the product without requiring manual text entry, each additional clickable prompt button, when activated, triggering the generation of new contextually relevant prompts based on the user's ongoing interaction with the product detail page.

12. The system of claim 11, wherein the product-related information provided to the user viewing the e-commerce website comprises at least one of: (i) condensed overviews of customer reviews generated by analyzing a customer review database, (ii) comparable product suggestions based on current product selection obtained from a product catalog database, (iii) items frequently bought together with a selected product derived from a purchase history database, and (iv) top-selling products within a same category accessed from a sales transaction database.

13. The system of claim 11, wherein the instructions that cause the system to track user interactions with the plurality of skills comprise instructions that cause the system to record: (i) a specific skill type activated, (ii) timing and sequence of skill activations, (iii) product context in which a skill was activated, and (iv) selections made by a user during skill interaction.

14. The system of claim 11, wherein the instructions that cause the system to analyze the tracked user interactions comprise instructions that cause the system to determine user implied needs and interests.

15. The system of claim 11, wherein the prompt template repository contains prompt templates categorized by widget type, detected user intent, product category, and stage in customer process.

16. The system of claim 11, wherein the instructions that cause the system to generate the contextually relevant prompts comprise instructions that cause the system to: (i) retrieve relevant product data from at least one external database associated with an activated skill; (ii) combine the retrieved product data with a user's interaction context; and (iii) process the combined data through the LLM to generate the contextually relevant prompts.

17. The system of claim 11, wherein the additional clickable prompt buttons are dynamically prioritized and reordered based on their predicted relevance to the user's current context and previous interactions.

18. The system of claim 11, wherein the instructions further cause the system to cache responses to frequently activated prompts to reduce response time for common queries without requiring repeated LLM processing.

19. The system of claim 11, wherein the instructions further cause the system to determine an optimal number of additional clickable prompt buttons to display based on the user's device type, screen size, and historical engagement metrics.

20. A computer-implemented method, comprising:
generating a plurality of interactive prompt elements for display on a web page, each interactive prompt element comprising a clickable prompt button that performs a specific function to provide information to a user viewing the web page;
detecting a user engagement with at least one of the interactive prompt elements on the web page displayed at a computing device;
determining a type of interactive prompt element being engaged;
upon determining the type of interactive prompt element being engaged by the user:
transmitting, to an interactive large language model (LLM) at a remote server, from the computing device, contextual information including at least one of: systemic context information, user context information, and user interaction history;
processing, by the LLM at the remote server, the contextual information to generate parametric output data customized based on the type of interactive prompt element engaged and the identified user preferences;
optionally requesting, based on the type of interactive prompt element engaged, additional user input via an interface element;
optionally processing, by at least one external data processing system, a portion of the contextual information to generate supplementary data; and
transmitting, from the remote server to the computing device, response data comprising at least one of: the parametric output data and the supplementary data, responsive to the interactive prompt element being engaged by the user;
generating, based on the user's ongoing interaction with the web page, additional contextually relevant interactive prompt elements for display on the web page, enabling the user to initiate follow-up queries without requiring manual text entry.
